(19) United States
(12) Patent Application Publication
(10) Pub. No.: US 2012/0075707 A1
(43) Pub. Date: Mar. 29, 2012

(54) Adhesive Dots Attached Onto A Film

(76) Inventor: Jean G. Atallah, Fremont, CA (US)

(21) Appl. No.: 12/889,885

(22) Filed: Sep. 24, 2010

(51) Int. Cl. G02B 1/11; B32B 37/00; B32B 3/00

(52) U.S. Cl. 359/601; 428/156; 156/64

(57) ABSTRACT

A film including a rear surface to couple to a screen of a display device, adhesive dots attached onto the rear surface of the film at a distance from one another, where fluid between the rear surface of the film and the screen of the display device exit through the distance between the adhesive dots in response to the rear surface of the film coupling to the screen.

### BACKGROUND

When preparing a film for attaching onto a display device, glue, tape, or other adhesives can continuously be applied across one or more sides of the film. Once, the glue, tape, or adhesive has bonded to the film, the film can be applied onto a screen of the display device. When applying the film, a user can use his hand or a device to apply force to the film onto the surface of the display device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a film coupled to a display device according to an embodiment.

FIG. 2A illustrates a film with one or more layers according to an embodiment.

FIG. 2B illustrates a rear surface of a film according to an embodiment.

FIG. 3 illustrates a film with adhesive dots being coupled to a display device according to another embodiment.

FIG. 4 illustrates fluid exiting through a distance between adhesive dots in response to a film being applied to a screen of a display device according to an embodiment.

FIG. 5 is a flow chart illustrating a method for reducing fluid bubble formation according to an embodiment.

FIG. 6 is a flow chart illustrating a method for reducing fluid bubble formation according to another embodiment.

### DETAILED DESCRIPTION

By attaching adhesive dots onto a rear surface of a film, fluid between the rear surface of the film and a screen of a display device can exit through a distance between the adhesive dots in response to the rear surface of the film being coupled to the screen of the display device. A fluid can include one or more substances, such as a liquid or a gas, which can travel, flow, or exit through one or more distances between the adhesive dots. As a result, fluid bubble formation between the rear surface of the film and the screen can be reduced or eliminated and a visually appealing experience can be created for a user using the display device with the film applied.

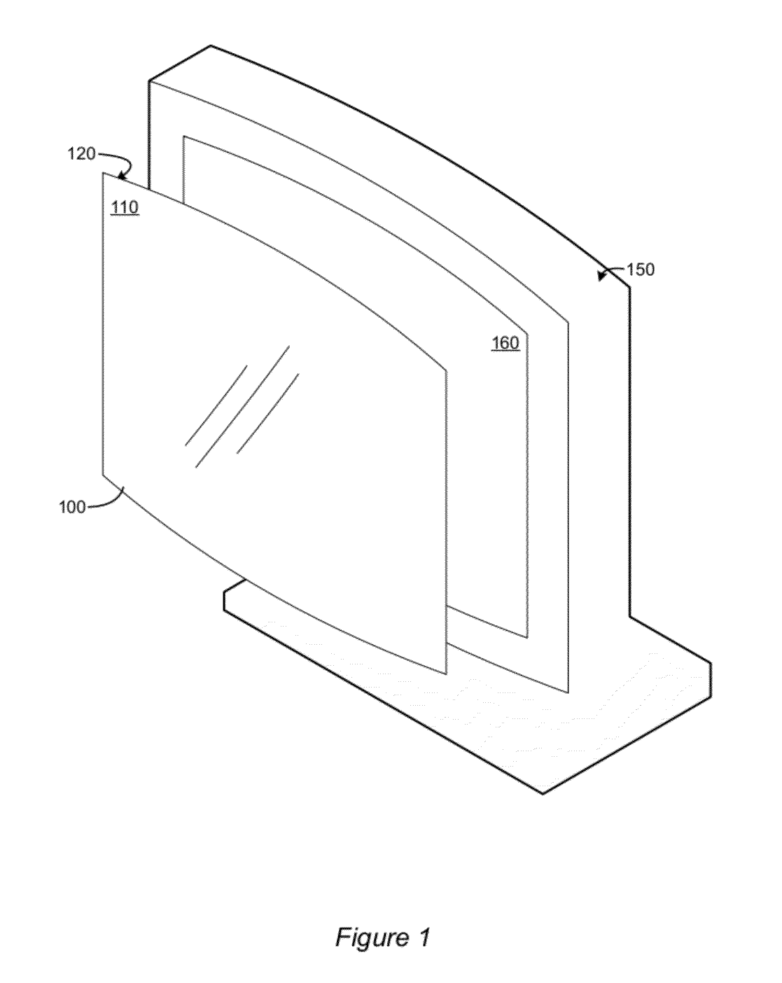

FIG. 1 illustrates a film 100 coupled to a display device 150 according to an embodiment. A film 100 can be a sheet of material which can include one or more layers. In one embodiment, the film 100 can be a protective screen, a privacy screen, and/or an antiglare screen. In other embodiments, the film 100 can include additional types of screens and can be used for additional purposes when coupled to a display device 150.

As illustrated in FIG. 1, the film 100 includes a front surface 110 and a rear surface 120. In one embodiment, the front surface 110 can be a first layer of the film 100 and the rear surface 120 can be a last layer of the film 100. In another embodiment, the film 100 includes a single layer and the front surface 110 is a front side of the single layer and the rear surface 120 is the back side of the single layer.

When coupling the film 100 to the display device 150, the rear surface 120 of the film 100 can couple to a screen 160 of the display device 150. In response to coupling with the screen 160, the film 100 can overlap and cover the entire screen 160 on the display device 100. In another embodiment, the film 100 can overlap and/or cover a portion of the screen 160 on the display device 150. In other embodiments, the film 100 can be coupled to other portions or surfaces of the display device 150 and/or any other device.

As illustrated in FIG. 1, the display device 150 can be an output device configured to render or display one or more images and/or videos through a screen 160 of the display device 150. The display device 150 may be for example a monitor, a television, an all in one computing machine, a PDA (personal digital assistant), a GPS (global positioning system), a cellular device, a laptop, a notebook, a netbook, a touch system, a handheld device, and/or any additional device configured to output one or more videos and/or images through a screen 160.

A screen 160 is a component of the display device 150 configured output, display, and/or render one or more images and/or videos. The screen 160 can include a CRT (cathode ray tube) display or a flat panel display. The flat panel display may be for example a LCD (liquid crystal display) display, a LED (light emitting diode) display, an ELD (electro luminescent display) display, a VFD (vacuum florescent display) display, a DLP (digital light processing) display, a LCoS (liquid crystal on silicon) display, and/or a plasma display panel. In other embodiments, the screen 160 can include additional display types, components, or devices configured to render and/or one or more images and/or videos.

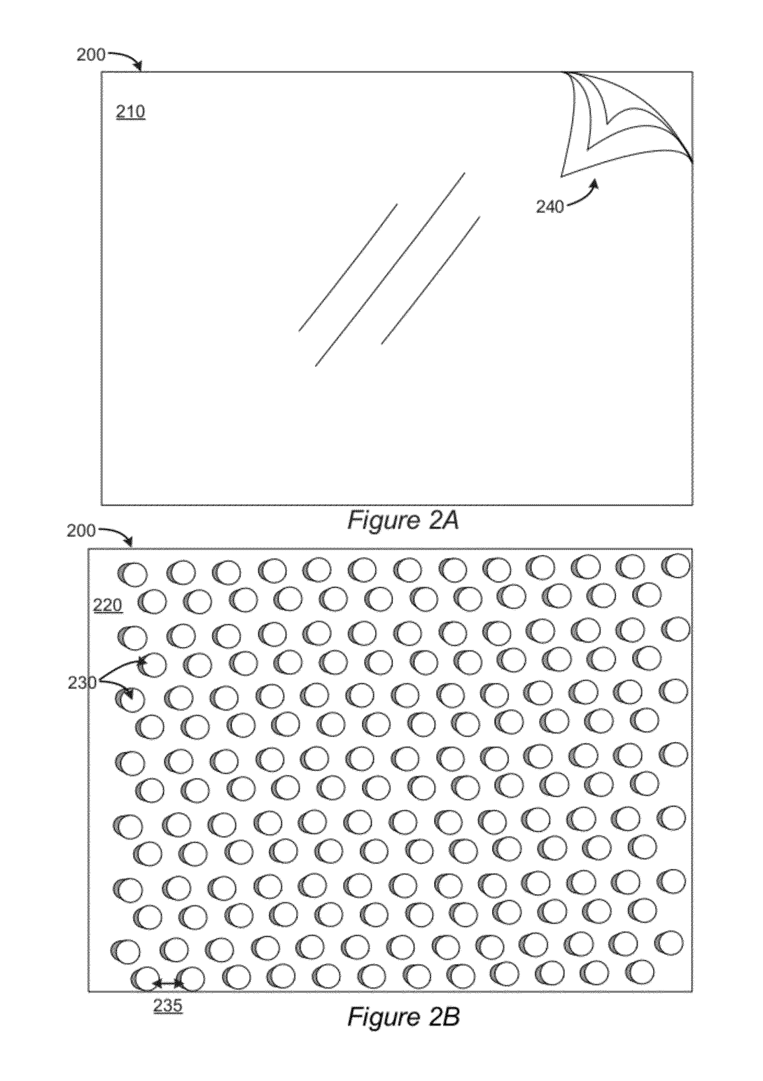

FIG. 2A illustrates a film 200 with one or more layers 240 according to an embodiment. As noted above and as illustrated in FIG. 2, the film 200 can include a front surface 210. In one embodiment, the front surface 210 can be a top layer of a plurality of layers 240 of the film 200. One or more of the layers 240 may for example be clear or transparent, vary in thicknesses, include one or more substances, and/or can overlap one another. In one embodiment, one or more of the layers 240 can be an anti-reflective layer, an anti-UV (ultra violet) layer, a mirror layer, an anti-scratch layer, and/or an adhesive layer.

Furthermore, one or more of the layers 240 can be made from one or more alloys, one or more synthetic or natural rubbers, one or more plastic materials, one or more glass materials, one or more silicone compounds, polyurethane, and/or a combination of the above. In other embodiments, one or more of the layers 240 can include additional types of layers and/or can be made from additional substances, materials, and/or compounds in addition to and/or in lieu of those noted above.

FIG. 2B illustrates a rear surface 220 of a film 200 according to an embodiment. The rear surface 220 can be a bottom layer of the film 200 and can include one or more adhesive dots 230 which can be attached onto the rear surface 220. One or more of the adhesives dots 230 can be a glue or bonding agent which join or bond the rear surface 220 of the film 200 to a screen of a display device. Additionally, one or more of the adhesive dots 230 can include one or more shapes and can be in a semi liquid state, and/or a solid state. As illustrated in the present embodiment, a shape of one or more of the adhesive dots 230 can include a cylindrical shape.

The adhesive dots 230 can be attached onto one or more portions of the rear surface 220. As illustrated in the present embodiment, the adhesive dots 230 can be attached across one or more portions of the rear surface 220 in a matrix pattern. In another embodiment, the adhesive dots 230 can be attached around a perimeter of the rear surface 220 of the film 200 and may not be included in one or more of the portions of the rear surface 220, such as the middle portion of the rear surface 220. In other embodiments, the adhesive dots 230 can be attached onto additional portions of the rear surface 220 of the film 200 and/or in additional patterns in addition to those noted above and illustrated in FIG. 2B.

As illustrated in FIG. 2B, the adhesive dots 230 can be attached onto the rear surface 220 at a distance 235 from one another. In one embodiment, the distance 235 which the adhesive dots 230 are attached from one another is based on a density of the adhesive dots 230. The density of the adhesive dots 230 can correspond to a mass of the adhesive dots 230. In one embodiment, by modifying the mass of the adhesive dots 230, a surface area of the adhesive dots 230 can correspondingly be increased and/or decreased. By modifying the mass and/or the surface area of the adhesive dots 230, the bonding strength of the adhesive dots 230 can be increased or decreased according to a mass of the film 200.

In one embodiment, the mass and/or the surface area of the adhesive dots 230 can be increased and/or decreased in response to modifying a type or an amount of one or more substances or materials included in the adhesive dots 230. One or more of the adhesive dots 230 can include a solvent adhesive, a synthetic monomer adhesive, a synthetic polymer adhesive, and/or an organic adhesive. In another embodiment, one or more of the adhesive dots 230 can include a pressure sensitive adhesive, a contact adhesive, and/or a drying adhesive. In other embodiments, one or more of the adhesive dots 230 can include additional types of adhesives which couple the rear surface 220 of the film 200 to a screen in addition to and/or in lieu of those noted above.

If the mass and/or surface area of the adhesive dots 230 is increased, a bonding strength of the adhesive dots 230 can be correspondingly increased to provide adhesiveness for a greater mass of the film 200. In one embodiment, in response to increasing the mass and/or the surface area of the adhesive dots 230, the distance 235 to attach the adhesive dots 230 from one another can also be increased. If the mass and/or the surface area of the adhesive dots 230 is decreased, a bonding strength of the adhesive dots 230 can be correspondingly decreased to provide adhesiveness for a decreased mass of the film 200. In one embodiment, in response to decreasing the mass and/or the surface area of the adhesive dots 230, the distance 235 to attach the adhesive dots 230 from one another can be decreased.

When attaching the adhesive dots 230 to the rear surface 220 of the film 200, a size, a shape, a density, and/or a distance 235 to attach the adhesive dots 230 from one another can be controlled and/or modified. In one embodiment, one or more of the adhesive dots 230 can be attached and/or printed onto the rear surface 220 of the film 200 using a device. The device can include a printer and/or any additional device which can attach one or more of the adhesive dots 230 onto the rear surface 220 of the film 200 at the distance 235 from another.

In one embodiment, the device can determine and/or modify a density of one or more of the adhesive dots 230 when controlling or modifying a size, a shape, and/or a distance 235 to attach one or more corresponding adhesive dots 220 from one another. In other embodiments, a size, a shape, and/or a distance 235 to attach one or more of the adhesive dots 230 from one another can be controlled and one or more of the adhesive dots 230 can be attached onto the rear surface 220 manually or using other additional means.

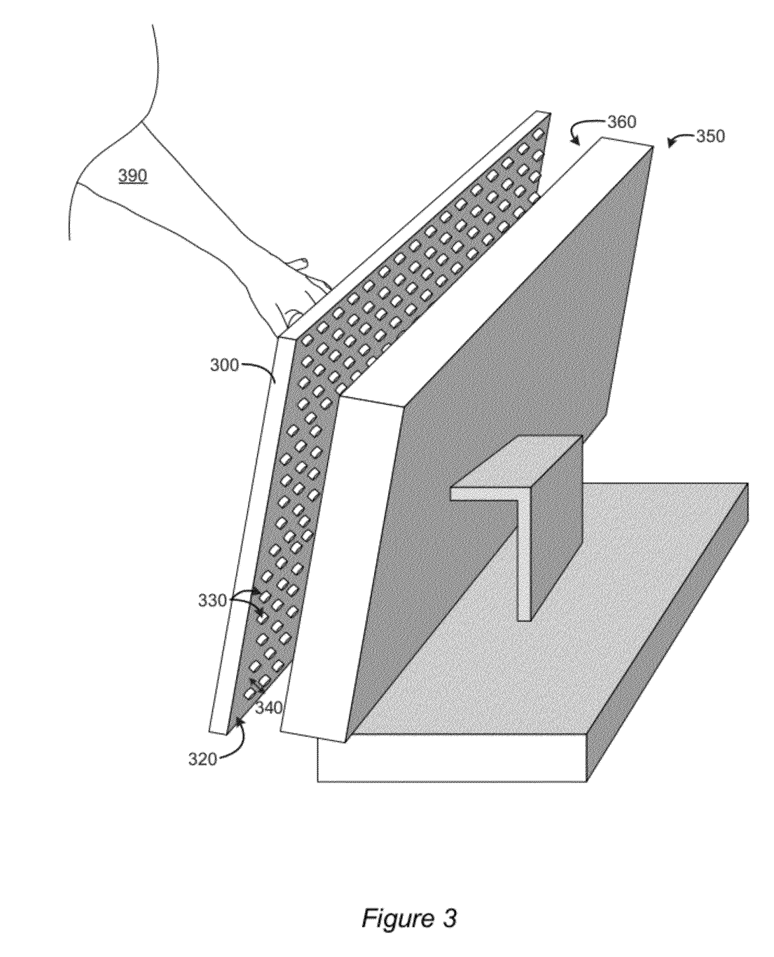

FIG. 3 illustrates a film 300 with adhesive dots 330 being coupled to a display device 350 according to an embodiment. As shown in the present embodiment, a user 390 can apply a rear surface 320 of the film 300 to a screen 360 of the display device 350 using adhesive dots 330 attached onto the rear surface 320. When coupling the rear surface 320 to the screen 360, the user 390 can apply force to one or more areas of the film 300. In one embodiment, the user 390 can initially apply force to one area of the film 300 and continue to move and apply force to other areas of the film 300. The user 390 can use an instrument to apply the force. In one embodiment, the instrument can be made of a rubber, a plastic, a metallic, a wood, and/or a cardboard.

In response to the rear surface 320 of the film 300 being applied or coupled to the screen 360, the adhesive dots 330 will attach or couple to the screen and form a bond with the screen 360. As noted above, a density of the adhesive dots 330 can be adjusted to modify a strength of the bond between the rear surface 330 and the screen 360. A density of the adhesive dots 330 can be modified to increase or decrease a strength of the bond between the rear surface 320 of the film 300 and the screen 360 of the display device 350. As noted above, a density of the adhesive dots 330 can correspond to a mass and/or a surface area of the adhesive dots 330.

In one embodiment, the mass and/or the surface area can be controlled or modified in response to a type or an amount of a substance or material included in the adhesive dots 330. The type or the amount of a substance and/or material included in the adhesive dots 330 can be controlled and/or modified using a printing device or when the film 300 is manufactured. In one embodiment, if the density of the adhesive dots 330 is increased, the bond between the rear surface 320 of the film 300 and the screen 360 of the display device 350 can be increased. In another embodiment, the density of the adhesive dots 330 can be decreased. If the density of the adhesive dots 330 is decreased, the bond between the rear surface 320 of the film 300 and the screen 360 of the display device 350 can be decreased. By decreasing the strength of the bond, the film 300 can more easily be removed and/or reapplied to the screen 360 of the display device 350.

Furthermore, in response to modifying a density of the adhesive dots 330, a distance to attach the adhesive dots 330 from one another may be increased or decreased. If the density of the adhesive dots 330 is increased, the mass and/or the surface area of the adhesive dots 330 can be increased. In response to increasing the surface areas, the distance to attach the adhesive dots 330 from one another can be increased. If the density of the adhesive dots 330 is decreased, the mass and/or the surface area of the adhesive dots 330 can be decreased. In response to the surface area decreasing, the distance to attach the adhesive 330 from one another may be decreased.

If the rear surface 320 of the film 300 is attached to the screen 360 of the display device 300, one or more distances between the adhesive dots 330 can be used to reduce fluid bubble formation between the rear surface 320 and the screen 360 by providing space for fluid to exit or escape using the distance between the adhesive dots 330. Additionally, fluid bubbles can be formed when fluid is trapped between the rear surface 320 of the film 300 and the screen 360 of the display device 350. As noted above, a fluid can include one or more substances, such as a liquid or a gas, which can flow or exit through one or more spaces. In one embodiment, the fluid can include air.

In one embodiment, the space which the fluid can flow or exit through can include one or more channels. One or more channels are pathways which reduce fluid bubble formation by allowing fluid to exit between the rear surface 320 of the film 300 and the screen 360 of the display device 350. One or more of the channels include the distance between one or more of the adhesive dots 330, a shape of one or more of the adhesive dots 330, and/or a gap which can remain between the rear surface 320 of the film 300 and the screen 360 of the display device 350 when the film 300 is coupled to the screen 360 or the display device 350. The gap can correspond to a length or height 340 of one or more of the adhesive dots 330. In one embodiment, the adhesive dots 330 have a cylindrical shape which can further increase a size or an amount of space of one or more of the channels for the fluid to exit or escape. In another embodiment, the adhesive dots 330 can include additional shapes used to provide one or more channels for fluid to exit and reduce fluid bubble formation.

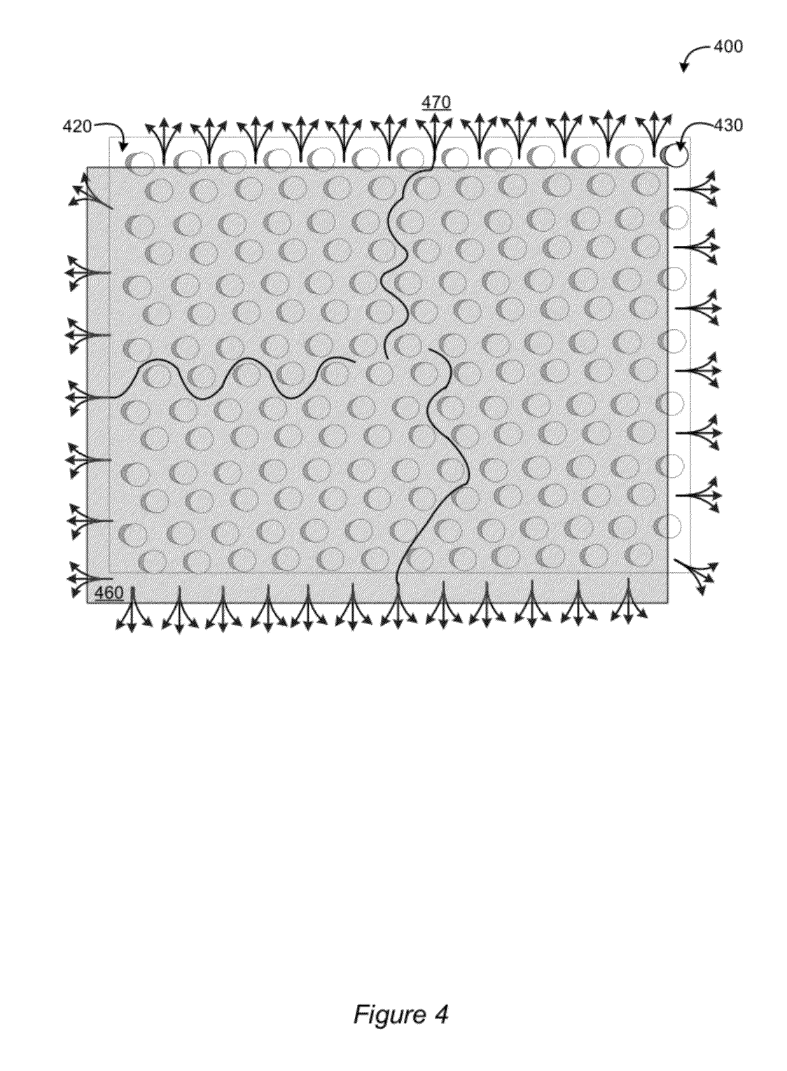

FIG. 4 illustrates fluid exiting through a distance between adhesive dots 430 in response to a film 400 being applied to a screen 460 of a display device according to an embodiment. In one embodiment, as the film 400 is being coupled to the screen 460, fluid between the rear surface 420 of the film 400 and the screen 460 proceed to exit through spaces between the film 400 and the screen 460. As noted above and as illustrated in FIG. 4, the space includes one or more channels 470 which can include a distance between one or more of the adhesive dots 430, a shape of one or more of the adhesive dots 430, and/or a gap (a height or length of the adhesive dots 430) between the rear surface 420 of the film 400 and the screen 460.

One or more of the channels 470 can provide a path for fluid to exit an area between the screen 460 and the rear surface 420 of the film 400 in response to the film 400 being coupled to the screen 400 of the display. As the adhesive dots 430 of the rear surface 420 come in contact with the screen 460 and the film 400 becomes coupled with the screen 460, fluid between the rear surface 420 of the film 400 and the screen 460 can exit through the space and/or one or more of the channels. In one embodiment, force can further be applied to one or more areas on a front surface of the film 400 to continue to have any remaining fluid between the rear surface 420 of the film 400 and the screen 460 exit through one or more channels 470. As a result, fluid bubble formation between the film 400 and the screen 460 can be reduced.

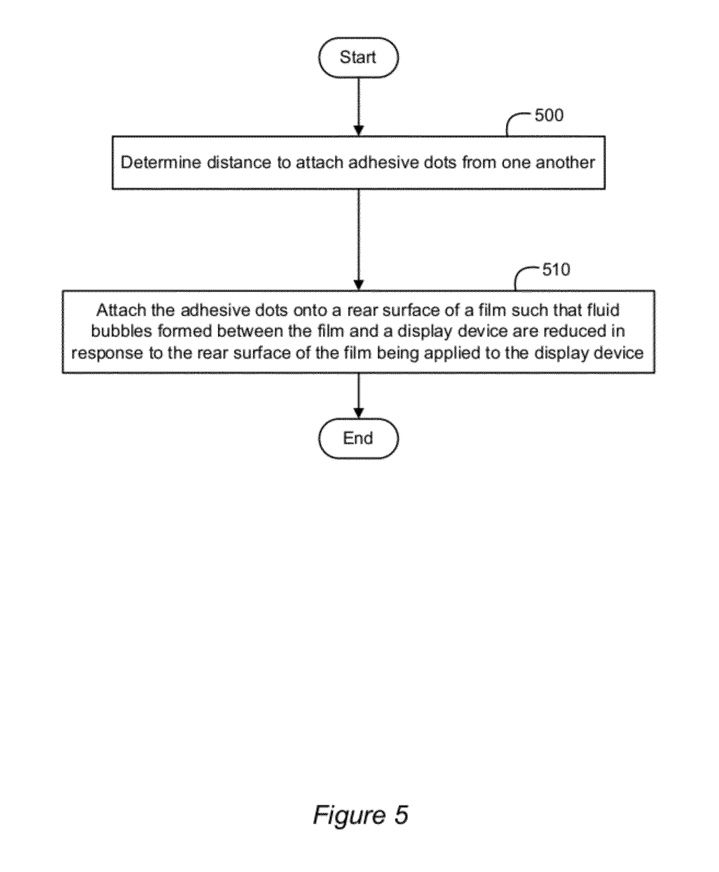

FIG. 5 is a flow chart illustrating a method for reducing fluid bubble according to an embodiment. The method of FIG. 5 uses a film with a front surface and a rear surface, one or more adhesive dots attached onto the rear surface, and a display device with a screen. In other embodiments, the method of FIG. 5 uses additional devices and/or components in addition to and/or in lieu of those noted above and illustrated in FIGS. 1, 2, 3, and 4.

As noted above, the film can be a sheet of one or more materials which can include one or more layers. The film can be a protective screen, a privacy screen, a UV screen, and/or an anti-glare screen. In other embodiments, the film can be additional screen types and/or be used for additional purposes in addition to and/or in lieu of those noted above. As noted above, the rear surface of the film can include one or more adhesive dots attached. The adhesive dots can include adhesive substances and/or materials and can be attached and/or printed onto the rear surface of the film at a distance from one another.

In one embodiment, a user and/or a device for attaching the adhesive dots can initially determine a distance to attach the adhesive dots from one another 500. The device can be a printing machine. As noted above, the distance to attach the adhesive dots from one another can be determined in response to a density of the adhesive dots. The density can correspond to a mass of the adhesive dots and/or a surface area of the adhesive dots. In one embodiment, the mass and/or the surface area of the adhesive dots can be controlled or modified in response to an amount of substance and/or material included in the adhesive dots.

As noted above, one or more of the substances and/or materials included in the adhesive dots can include a solvent adhesive, a synthetic monomer adhesive, a synthetic polymer adhesive, and/or an organic adhesive. Further, one or more of the adhesive dots can include a pressure sensitive adhesive, a contact adhesive, and/or a drying adhesive. In one embodiment, in response to increasing a density (mass or surface area) of one or more of the adhesive dots, a distance to attach the adhesive dots from one another can be increased.

As noted above, increasing the density of one or more of the adhesive dots can also increase a bonding strength between the film and a screen of a display device in response to the adhesive dots coupling to the screen. In another embodiment, in response to decreasing a density of one or more of the adhesive dots, a distance to attach the adhesive dots from one another can be decreased. As noted above, decreasing the density of the adhesive dots can also decrease a bonding strength between the film and the screen of the display in response to the adhesive dots coupling to the screen.

In response to determining the distance to attach the adhesive dots from one another, the user and/or the device can proceed to attach the adhesive dots onto the rear surface of the film at the determined distance from one another such that fluid bubbles formed between the film and the screen of the display device are reduced in response to the rear surface of the film being applied to the screen of the display device 510.

In one embodiment, the adhesive dots are attached across the rear surface of the film following a matrix pattern. In another embodiment, the adhesive dots are attached around a perimeter of the rear surface of the film. A shape of the adhesive dots can be cylindrical when attached onto the rear surface of the film. In another embodiment, the shape of the adhesive dots can include additional shapes and the adhesive dots can be attached onto the rear surface of the film in additional patterns and/or using additional methods in addition to and/or in lieu of those noted above.

The rear surface of the film can then be coupled and/or applied to a screen of a display device. As the film is being coupled to the screen, the adhesive dots will couple with the screen and fluid bubbles formation between the film and the screen can be reduced in response to fluid exiting through spaces between the film and the screen. The space can include one or more channels which allow fluid to continue to exit and reduce the formation of fluid bubbles. One or more of the channels include a distance between the adhesive dots, a shape of the adhesive dots, and/or a gap which remains between the rear surface of the film and the screen when the film is coupled to the screen. The method is then complete. In other embodiments, the method of FIG. 5 includes additional steps in addition to and/or in lieu of those depicted in FIG. 5.

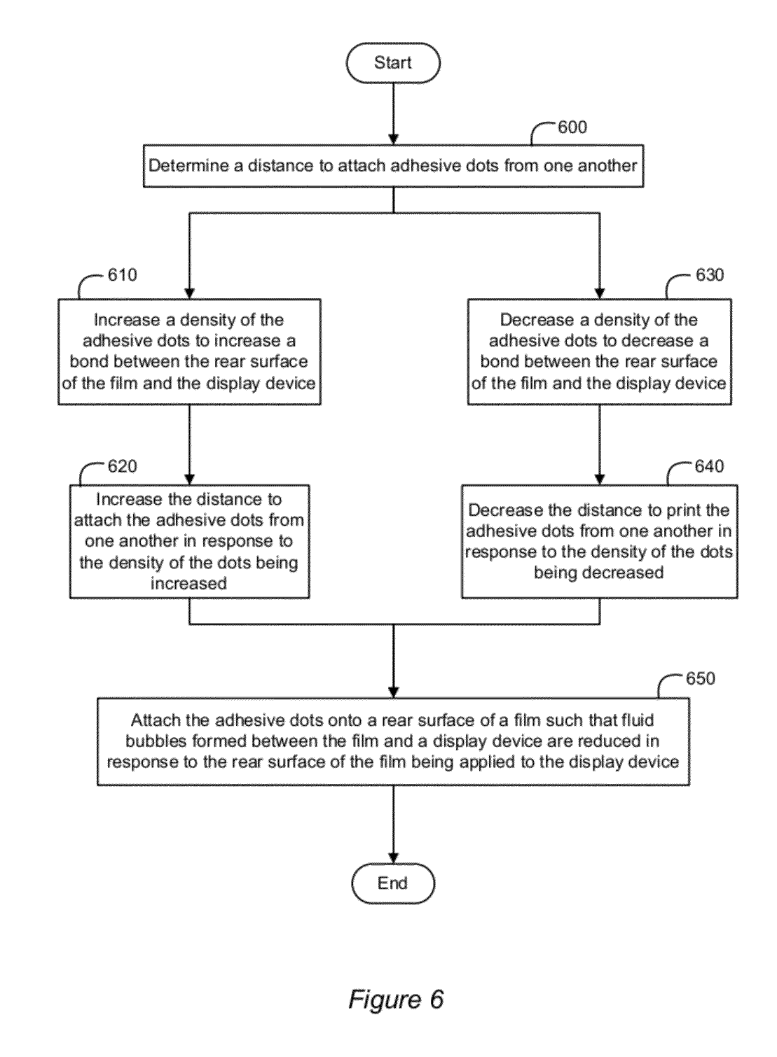

FIG. 6 is a flow chart illustrating a method for reducing fluid bubble formation according to another embodiment. Similar to the method disclosed above, the method of FIG. 6 uses a film with a front surface and a rear surface, one or more adhesive dots attached onto the rear surface, and a display device with a screen. In other embodiments, the method of FIG. 6 uses additional devices and/or components in addition to and/or in lieu of those noted above and illustrated in FIGS. 1, 2, 3, and 4.

As illustrated in FIG. 6, a user and/or a device used to attach adhesive dots onto a rear surface of the film can initially identify a distance to attach the adhesive dots from one another 600. When determining the distance to attach the adhesive dots from one another, the user and/or the device can identify a density of the adhesive dots. As noted above, the density of the adhesive dots correspond to a mass and/or a surface area of the adhesive dots. In one embodiment, the mass and/or the surface area of the adhesive dots can be increased and/or decreased in response to modifying an amount of one or more substances and/or materials included in the adhesive dots.

In one embodiment, if the density of the adhesive dots include a predefined density of XY, the adhesive dots can be printed at a predefined distance Z from one another. The predefined density XY and the predefined distance can be defined by the user and/or by the device. In one embodiment, the user and/or the device can increase a density of the adhesive dots to increase a bonding strength between the rear surface of the film and the screen of the display device 610. In response to increasing the density, the user and/or the device can further increase the distance to attach the adhesive dots from one another 620.

In another embodiment, the user and/or the device can decrease a density of the adhesive dots to decrease a bonding strength between the rear surface of the film and the screen of the display device 630. In response to decreasing the density, the user and/or the device can additionally decrease the distance to attach the adhesive dots from one another 640. By increasing and/or decreasing the strength of the bond between the rear surface of the film and the screen of the display device, the strength of the bond of the adhesive dots can be controlled to support films of different masses. Furthermore, by modifying the strength of the bond between the rear surface of the film and the screen of the display device, the film can be more easily removed or be more difficult to remove from the display device.

Once the distance to attach the adhesive dots from one another has been determined, the user and/or the device can proceed to attach the adhesive dots onto the rear surface of the film at the determined distance from one another such that fluid bubbles formed between the film and the display device are reduced in response to the rear surface of the film being applied to the screen of the display device 650. In one embodiment, attaching the adhesive dots onto the rear surface includes the user and/or the device printing the adhesive dots onto the rear surface.

Once the adhesive dots have been attached onto the rear surface of the film, the film can be coupled to the display device by coupling the rear surface and the adhesive dots to the screen of the display device. As noted above, in response to the film being coupled and/or applied to the screen, fluid between the rear surface of the film and the screen can exit through a space between rear surface and the screen. In one embodiment, the space includes one or more channels can be used operate as pathways for the fluid to exit.

A size and/or shape of one or more of the channels can include the distance between one or more of the adhesive dots, a shape of one or more of the adhesive dots, and/or a gap (a height or length of one or more of the adhesive dots) which remains between the rear surface of the film and the screen of the display device. In one embodiment, the user and/or the device can apply force to one or more areas of the front surface of the film to continue to have fluid exit through the space and/or one or more channels. The process is then complete the user and/or the device can continue to apply force to one or more areas of the front surface of the film until a satisfactory amount of fluid has exited through the space. In other embodiments, the method of FIG. 6 includes additional steps in addition to and/or in lieu of those depicted in FIG. 6.

What is claimed is:

1. A film comprising:
a rear surface to couple to a screen of a display device; and
adhesive dots attached onto the rear surface of the film at a distance from one another;
wherein fluid between the rear surface of the film and the screen of the display device exit through the distance between the adhesive dots in response to the rear surface of the film coupling to the screen.

2. The film of claim 1 wherein the distance between the adhesive dots is based on a density of the adhesive dots.

3. The film of claim 2 wherein the density of the adhesive dots correspond to at least one from the group consisting of a mass of the adhesive dots and a surface area of the adhesive dots.

4. The film of claim 1 wherein the adhesive dots are attached onto the rear surface of the film in a matrix pattern.

5. The film of claim 1 wherein the adhesive dots are attached around a perimeter of the rear surface of the film.

6. The film of claim 1 wherein a gap remains between the rear surface of the film and the display device if the adhesive dots have coupled to the display device.

7. The film of claim 1 wherein the adhesive dots consist of at least one from the group consisting of a solvent adhesive, a synthetic monomer adhesive, a synthetic polymer adhesive, and an organic adhesive.

8. The film of claim 1 wherein the adhesive dots consist of at least one from the group consisting of a pressure sensitive adhesive, a contact adhesive, and a drying adhesive.

9. A method for reducing fluid bubble formation comprising:
determining distance to attach adhesive dots from one another; and
attaching the adhesive dots onto a rear surface of a film such that fluid bubbles formed between the film and a display device are reduced in response to the rear surface of the film being applied to the display device.

10. The method for reducing fluid bubble formation of claim 9 wherein the distance to print the adhesive dots is determined in response to a density of the adhesive dots.

11. The method for reducing fluid bubble formation of claim 10 further comprising increasing the density of the adhesive dots to increase a bond between the rear surface of the film and the display device.

12. The method for reducing fluid bubble formation of claim 11 further comprising increasing the distance to print the adhesive dots from one another in response to the density of the dots being increased.

13. The method for reducing fluid bubble formation of claim 10 further comprising decreasing the density of the adhesive dots to decrease a bond between the rear surface of the film and the display device.

14. The method for reducing fluid bubble formation of claim 13 further comprising decreasing the distance to print the adhesive dots from one another in response to the density of the dots being decreased.

15. The method for reducing fluid bubble formation of claim 9 wherein the distance between the adhesive dots allow fluid between the rear surface of the film and the display device to exit in response to the film being applied to the display device.

16. A display device comprising:
a film to apply onto a surface of the display device; and
adhesive dots attached onto a rear surface of the film at a distance from one another;
wherein fluid between the rear surface of the film and the surface of the display device departs through the distance between the adhesive dots in response to the rear surface of the film being attached to the surface of the display device.

17. The display device of claim 16 wherein the fluid includes at least one from the group consisting of a liquid and a gas.

18. The display device of claim 16 wherein the surface of the display device is configured to render at least one from the group consisting of an image and a video.

19. The display device of claim 16 wherein the adhesive dots have a cylindrical shape.

20. The display device of claim 16 wherein the film includes at least one from the group consisting of a protective screen, a privacy screen, and an antiglare screen.
